(19) United States
(12) Patent Application Publication
(10) Pub. No.: US 2009/0218109 A1
(43) Pub. Date: Sep. 3, 2009

(54) Sprinkler Head Cover

(76) Inventor: Koki Sato, Iwate (JP)

Correspondence Address: WENDEROTH, LIND & PONACK, L.L.P., 1030 15th Street, N.W.,, Suite 400 East, Washington, DC, 20005-1503, US

(21) Appl. No.: 12/224,713

(22) PCT Filed: Jan. 22, 2007
(86) PCT No.: PCT/JP2007/050891

§ 371 Date: Jan. 30, 2009

(30) Foreign Application Priority Data
Mar. 6, 2006 (JP) 2006-058803
Mar. 27, 2006 (JP) 2006-085370

(51) Int. Cl. A62C 35/68

(52) U.S. Cl. 169/37

(57) ABSTRACT

An object of the present invention is to provide a sprinkler head cover comprising a cylindrical retainer having a sprinkler head housed inside it, and a cover plate in the form of plate to be connected to a flange formed in a lower end of the retainer, which sprinkler head cover would not block the dispersing water during water dispersion upon activation of the sprinkler head, and would not deteriorate the bonding strength between the retainer and the cover plate.

Each of a plurality of legs 6 extending downward from a lower end of a retainer 1 is configured to bend so that the tip portion of the leg is horizontally oriented, and also to have a smaller cross sectional area of a downward extending segment 9 than that of a horizontal segment 7 of the tip portion of each leg. Alternatively, the leg 6 may be configured to extend downward radially and to be bent such that its tip portion is horizontally oriented.

### TECHNICAL FIELD

The present invention relates to a sprinkler head cover to be attached to a sprinkler head for extinguishing a fire.

### PRIOR ART

A sprinkler head cover is provided to cover a sprinkler head protruding from a lower surface of a ceiling so the sprinkler head is not seen directly, and it comprises a cylindrical retainer with a sprinkler head contained inside it and a cover plate in the form of a plate to be connected to a lower end of the retainer (see, for example, Patent document 1).

In one configuration of a connection between the retainer and the cover plate, a plurality of legs extending downward from the lower end of the retainer are bent at the tips thereof so as to be oriented horizontally to form bonding surfaces. The bonding surface and the cover plate are soldered to each other by using a fusible alloy, and the fusible alloy employed herein for the sprinkler head cover may be predominantly such a fusible alloy that would melt at a lower temperature than an operating temperature of the sprinkler head so as not to inhibit activation of the sprinkler head.

In case of fire, the fusible alloy used for bonding the retainer and the cover plate together will melt first to permit the cover plate to fall, and once the sprinkler head is activated, as it is exposed to a hot air stream from the fire, a nozzle inside the sprinkler head is opened to release a volume of water, which will in turn impinge upon a deflector and disperse around within a room space to accomplish fire extinguishing activity.

Patent document 1: Registered Utility Model Publication No. 3016985

### DISCLOSURE OF THE INVENTION

### Problem to be Solved by the Invention

As the cover plate is disengaged and thus falls down from the retainer due to melting of the fusible alloy by heat from the fire, as described above, the legs of the retainer will be left as they are suspended from the ceiling surface. Subsequently, when the sprinkler head is activated to allow a volume of water to disperse, problematically, the legs of the retainer will become an obstacle to reduce a volume of water that will successfully disperse in a direction corresponding to the locations of the legs of the retainer.

Accordingly, the smaller legs of the retainer should be less likely to disturb the dispersion of water by the sprinkler head as activated. However, the smaller leg portion may reduce a surface area of the bonding surface with the cover plate, possibly leading to a deteriorated bonding strength. If the bonding strength with the cover plate is decreased, there is a possibility of the cover plate falling due to a shock of earthquake, for example, or a danger of injuries, such as the falling cover plate hitting a person's head.

In light of the circumstances described above, an object of the present invention is to provide a sprinkler head cover configured not to disturb the dispersing water during the water dispersion upon activation of the sprinkler head, yet without deteriorating the bonding strength between the retainer and the cover plate.

### Means for Solving the Problems

To accomplish the object as stated above, the invention as set forth in claim 1 provides a sprinkler head cover comprising a cylindrical retainer having a sprinkler head housed inside thereof, and a cover plate in a form of plate to be connected to a flange formed in a lower end of the retainer, in which a plurality of legs are formed to extend downward from the flange, and a segment of each leg at a tip side is bent so as to be parallel with the flange so as to form a connection surface with the cover plate, wherein a cross sectional area of a downward extending segment of the leg is smaller than that of the connection surface.

The invention as set forth in claim 2 provides a sprinkler head cover comprising a cylindrical retainer having a sprinkler head housed inside it, and a cover plate in a form of plate to be connected to a flange formed in a lower end of the retainer, in which a plurality of legs are formed to extend downward from the flange, wherein each of the leg, is configured to extend downward radially at a certain angle of inclination and a segment of the leg at a tip side is bent so as to be parallel with the flange so as to form a connection surface with the cover plate.

The invention as set forth in claim 3 provides a sprinkler head cover in accordance with the invention defined in claim 1 or 2, in which a width of a downward extending segment of each leg is narrower than that of a horizontal segment of the tip of the leg.

The invention as set forth in claim 4 provides a sprinkler head cover in accordance with the invention defined in claim 1 or 2, in which an aperture is formed in the downward extending segment of each leg.

The invention as set forth in claim 5 provides a sprinkler head cover comprising a cylindrical retainer having a sprinkler head housed inside thereof, and a cover plate in a form of plate to be connected to a flange formed in a lower end of the retainer, in which a plurality of legs are formed in the flange to be suspended radially therefrom, wherein a segment of each leg at a tip side is bent so as to be parallel with the flange so as to form a connection surface with the cover plate.

The invention as set forth in claim 6 provides a sprinkler head cover in accordance with the invention defined in claim 5, in which the leg formed in the flange is configured by bending a part of the flange downward along a radius of the flange.

The invention as set forth in claim 7 provides a sprinkler head cover in accordance with the invention defined in any one of claims 1, 2 and 5, in which a peripheral edge area of a flange portion formed in the retainer lower end is in contact with a ceiling surface.

The invention as set forth in claim 8 provides a sprinkler head cover in accordance with the invention defined in claim 7, in which the flange portion is inclined downward with respect to a horizontal plane from a peripheral edge toward a center thereof.

The invention as set forth in claim 9 provides a sprinkler head cover in accordance with the invention defined in any one of claims 1 and 5, in which a plurality of legs and connection surfaces with the cover plate are formed at a location where the leg formed in the flange is disposed.

### EFFECT OF THE INVENTION

In each leg of the retainer protruding from the ceiling surface, by arranging the aperture in the downward extending segment or by making the width of the downward extending segment narrower than the horizontal segment so that the cross sectional area of the downward extending segment of the leg may be relatively smaller as compared to that of the horizontal segment of the leg, the area of impingement in the downward extending segment by the stream of water released from the sprinkler head as it is activated can be reduced, thus the region where dispersing water is blocked can be reduced.

Further, by forming the leg of the retainer such that it extends downward radially at a certain angle of inclination, a volume of water released from the sprinkler head as it is activated can be guided to splash diagonally downward, and thus it will become possible to permit the water to splash diagonally downward with respect to the orientation of the leg.

Further, by bending the downward extending segment of the leg of the retainer downward along the radius of the flange of the retainer, it will become possible to maximally reduce an area that will potentially become an obstacle to the stream of water to be released from the sprinkler head.

According to the effects described above, since the downward extending segment can be formed such that it would not block the stream of water from the sprinkler head 3, it is feasible to enhance the bonding strength to the cover plate by increasing the number of downward extending segments to be provided.

### PREFERRED EMBODIMENTS OF THE INVENTION

Preferred embodiments of the present invention will be described below with reference to FIGS. 1 to 3. FIG. 1 shows a sectional view of a sprinkler head cover attached to a sprinkler head of the present invention, FIG. 2 represents embodiments of a leg of a retainer and FIG. 3 shows the sprinkler head as shown in FIG. 1, when it is activated.

The sprinkler head cover as shown in FIG. 1 comprises a retainer 1 and a cover plate 2. The retainer 1 is cylindrical in configuration and its upper portion includes a plurality of pawls 4 protruding toward a center so that it can be engaged to an outer circumferential surface of the sprinkler head 3. A lower end of the retainer 1 provides a flange 5 in the form of collar and has a plurality of legs 6 configured to suspend from the flange 5.

A peripheral edge of the flange 5 is configured to rise toward a ceiling and the peripheral edge portion is exclusively in contact with the ceiling. This is intended to allow the peripheral edge of the flange 5 to be placed in contact with the ceiling surface, even if there is a burr at an edge of a hole H drilled through the ceiling for the sprinkler head installed in the inside space of the ceiling to protrude into the space of the room, by taking a design into account. It is possible, in addition to the configuration as suggested in FIG. 1, to have such a flange 5 that is configured to slope from the peripheral edge toward the center thereof.

The leg 6 is bent such that a tip is oriented horizontally and a bonding surface 7 defined on the tip side is bonded with the cover plate 2 by use of a fusible alloy 8. A downward extending segment 9 of the leg 6 is configured to be narrower than a width of the bonding surface 7 so as not to become an obstacle to a stream of water released from the sprinkler head 3 as it is activated (see FIG. 2(a)).

The configuration of the downward extending segment 9 is not limited to that described above, but other designs may be used, including, for example, the one provided with an aperture 10 as shown in FIG. 2(b), or the one having a downward extending segment 9 that is configured to be skewed, as represented by that having a narrowly shaped sloped surface (FIG. 2(c)) or that having an aperture in the sloped surface (FIG. 2(d)).

In addition, if the bending position of the leg 6 is configured such that it is bent along the radius of the flange 5 as shown in FIG. 2(e), a volume of water released from the sprinkler head inside the retainer 1 can splash around substantially without any interference by the leg 6.

According to the configuration as described above, since the downward extending segment 9 can be provided in such a manner as not to block the stream of water from the sprinkler head 3, it is feasible to enhance the bonding strength with the cover plate by increasing the number of legs to be provided. In one example, two legs 6 with two bonding surfaces 7 may be formed at a single location for a leg to be disposed, as shown in FIG. 2(f) or FIG. 2(g).

The cover plate 2 is made in the form of a disc and connected to the leg 6 of the retainer 1 by using a fusible alloy 8, as stated above. Preferably, the fusible alloy 8 to be used may have a melting point lower than an operating temperature of the sprinkler head 3.

Further, it is also possible that a spring member, which is not shown, may be interposed between the flange 5 and the cover plate 2. If provided, the spring member will effectively facilitate falling of the cover plate 2, upon melting of the fusible alloy 8.

The description is further continued and an operation of the sprinkler head cover will be now described.

At normal times, the sprinkler head cover serves to cover the sprinkler head 3 so as not to be seen from the room side, so that only the cover plate 2 is exposed out from the ceiling surface. In case of fire, the fusible alloy 8 connecting the retainer 1 with the cover plate 2 will melt due to heat from the fire, and the cover plate 2 will fall.

As the cover plate 2 falls, the sprinkler head 3 within the retainer 1 becomes exposed and a deflector 12 is lowered to a predetermined level. A hot air stream from the fire flows into the interior space of the retainer 1 to activate a heat-sensitive decomposition structure 11 of the sprinkler head. The activation of the heat-sensitive decomposition structure 11 will disengage the valve plug of the sprinkler head to permit a volume of water within a piping to be released from a nozzle, not shown (see FIG. 3).

The volume of water released from the nozzle will impinge upon the deflector 12 and splash in all directions. While this occurs, owing to the narrowly formed leg 6 of the retainer 1, the volume of water can also disperse in the outward direction beyond the leg 6, thus reducing the region in which no water is dispersed. Further, if the leg 6 is configured to make a slope as shown in FIG. 2(c) and FIG. 2(d), the water once having impinged upon the leg 6 now flows diagonally downward along the sloped surface so as to disperse in the outward direction of the leg, thus reducing the region in which no water is dispersed.

Although the above embodiment has been described as using the sprinkler head having such a structure in which the deflector is lowered to the predetermined level as a result of the falling of the cover plate, the present invention is not thus limited but includes such a sprinkler head having a structure in which the deflector is lowered after the activation of the sprinkler head.

### BRIEF DESCRIPTION OF THE DRAWINGS

FIG. 1 is a sectional view of a sprinkler head cover attached to a sprinkler head according to the present invention;

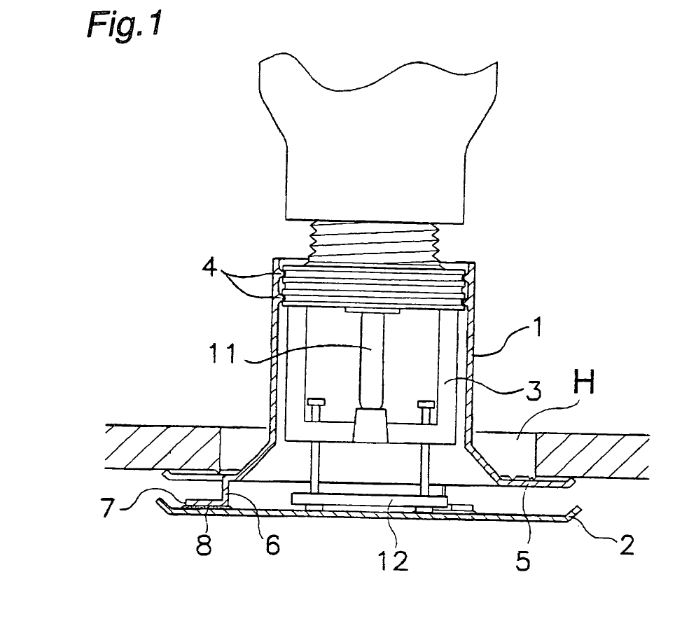

FIG. 2 presents some embodiments of a leg of a retainer; and

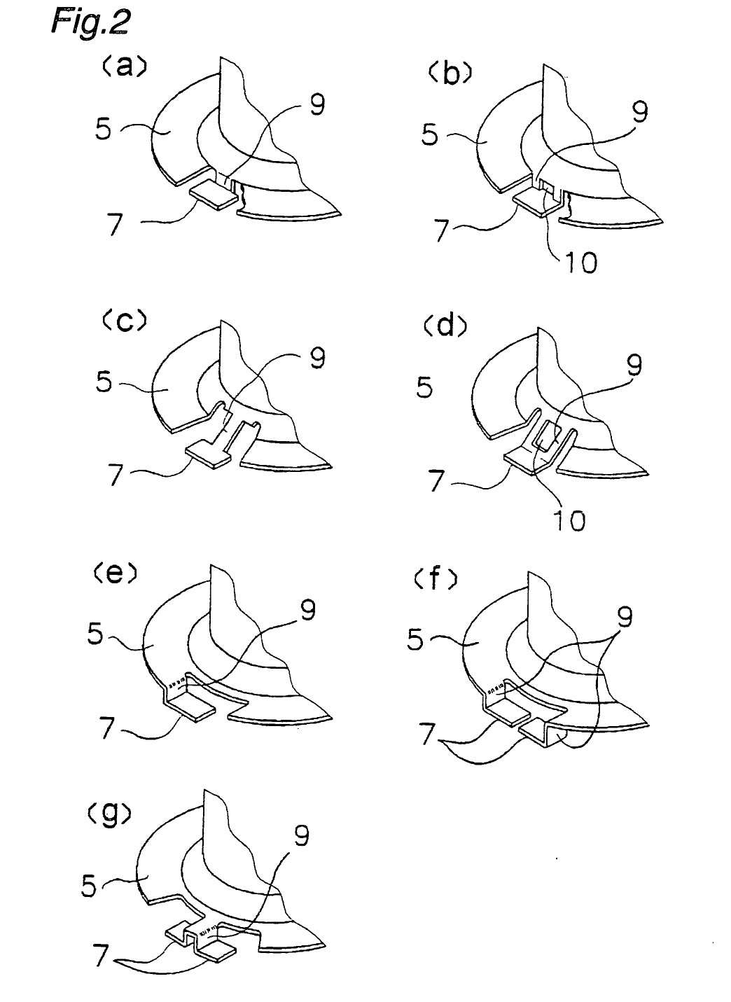

FIG. 3 shows a sprinkler head as shown in FIG. 1, when it is activated.

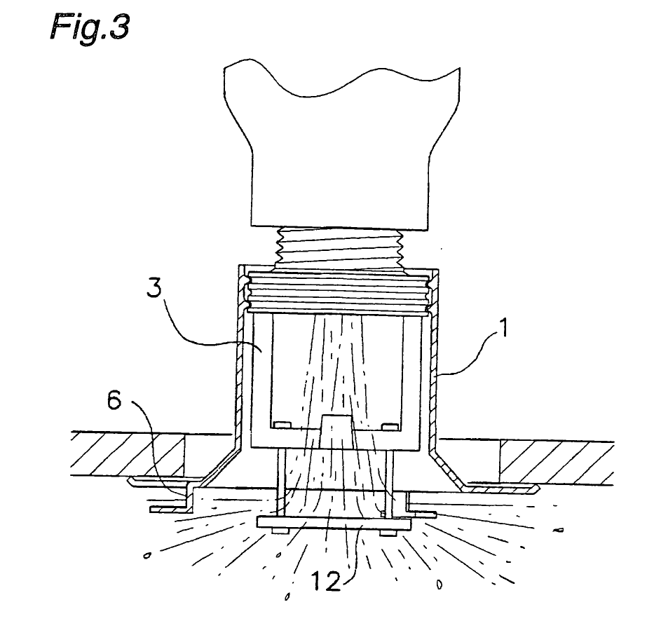

### EXPLANATION OF THE REFERENCE NUMERALS

1 Retainer
2 Cover plate
3 Sprinkler head cover
4 Pawl
5 Flange
6 Leg
7 Horizontal segment
8 Fusible alloy
9 Downward extending segment

1. (canceled)

2. A sprinkler head cover comprising a cylindrical retainer having a sprinkler head housed inside it, and a cover plate in the form of a plate to be connected to a flange formed in a lower end of said retainer, said sprinkler head cover characterized in that a plurality of legs are formed to extend downward from said flange, wherein each of said legs is configured to extend downward radially at a certain angle of inclination and a segment of each of said legs at a tip side is bent so as to be parallel with said flange so as to form a connection surface with said cover plate.

3. (canceled)

4. A sprinkler head cover comprising a cylindrical retainer having a sprinkler head housed inside it, and a cover plate in a form of plate to be connected to a flange formed in a lower end of said retainer, in which a plurality of legs are formed to extend downward from said flange, said sprinkler head cover characterized in that an aperture is formed in said downward extending segment of each of said legs.

5. A sprinkler head cover comprising a cylindrical retainer having a sprinkler head housed inside thereof, and a cover plate in the form of a plate to be connected to a flange formed in a lower end of said retainer, said sprinkler head cover characterized in that a leg formed by bending a part of said flange downward along a radius of said flange is provided, wherein a segment of each of said legs at a tip side is bent to be horizontal so as to form a connection surface with said cover plate.

6. (canceled)

7. A sprinkler head cover in accordance with claim 2, wherein a peripheral edge area of a flange portion formed in said retainer lower end is in contact with a ceiling surface.

8. A sprinkler head cover in accordance with claim 7, wherein said flange portion is inclined downward with respect to a horizontal plane from the peripheral edge toward a center thereof.

9. A sprinkler head cover comprising a cylindrical retainer having a sprinkler head housed inside it, and a cover plate in a form of plate to be connected to a flange formed in a lower end of said retainer, said sprinkler head cover characterized in that a plurality of legs are formed to extend downward from said flange, wherein a pair of symmetrically formed legs and connection surfaces with said cover plate are formed at a location where said legs are formed.

10. A sprinkler head cover in accordance with claim 5, wherein a peripheral edge area of a flange portion formed in said retainer lower end is in contact with a ceiling surface.

11. A sprinkler head cover in accordance with claim 9, wherein said downward extending segment of each of said legs is bent downward along a radius of said flange of said retainer.

12. A sprinkler head cover comprising a cylindrical retainer having a sprinkler head housed inside it, and a cover plate in a form of plate to be connected to a flange formed in a lower end of said retainer, in which a plurality of legs are formed to extend downward from said flange, a segment of each of said legs at a tip side being bent so as to be parallel with said flange so as to form a connection surface with said cover plate, said sprinkler head cover characterized in that an aperture is formed in each of said legs between said flange and said connection surface with said cover plate.

13. A sprinkler head cover comprising a cylindrical retainer having a sprinkler head housed inside it, and a cover plate in a form of plate to be connected to a flange formed in a lower end of said retainer, said sprinkler head cover characterized in that a leg formed by bending a part of said flange downward along a line passing through a center of said flange and corresponding to a radius of said flange is provided, wherein a segment of said leg at a tip side is bent so as to form a connection surface with said cover plate.

14. A sprinkler head cover in accordance with claim 12, wherein a peripheral edge area of a flange portion formed in said retainer lower end is in contact with a ceiling surface.

15. A sprinkler head cover comprising a cylindrical retainer having a sprinkler head housed inside it, and a cover plate in a form of plate to be connected to a flange formed in a lower end of said retainer, said sprinkler head cover characterized in that a plurality of legs and connection surfaces with said cover plate are formed in said flange, said legs and connection surfaces being formed by being bent downward symmetrically with respect to a line passing through a center of said flange and corresponding to a radius of said flange, taken as an axis of symmetry.

16. A sprinkler head cover in accordance with claim 13, wherein a peripheral edge area of a flange portion formed in said retainer lower end is in contact with a ceiling surface.
